(19) United States
(12) Patent Application Publication
(10) Pub. No.: US 2007/0150216 A1
(43) Pub. Date: Jun. 28, 2007

(54) A kind of active-source frequency-domain electromagnetic prospecting method

(76) Inventor: Jishan He, Changsha (CN)

Correspondence Address: Keqiang He, 5339 Crimson Sky Court, Centreville, VA, 20120, US

(21) Appl. No.: 11/306,420

(22) Filed: Dec. 28, 2005

(51) Int. Cl. G06F 19/00

(52) U.S. Cl. 702/64

(57) ABSTRACT

This invention sends the number of 2n+1 of pseudo-random waveform electric current distributed in 2n into ground as its excitation source by the transmitter, and at the same time receives and measures the electric potential difference, amplitude and phase (real and imaginary components) of each dominant frequency on the ground, the relative phase among every dominant frequency, then calculates many kinds of parameters, such as the apparent resistivity, amplitude frequency ratio of every dominant frequency. This invention, can not only replace the various kinds of existing active-source frequency-domain electromagnetic prospecting methods (including CSAMT, frequency-domain sounding method, frequency-domain induced polarization method and complex resistivity method), but also unite the whole active-source frequency-domain electromagnetic prospecting methods. Its characteristics include convenience, high efficiency, multiple parameter and high precision.

This invention sends the number of 2ⁿ+1 of pseudo-random waveform electric current distributed in 2ⁿ into ground as its excitation source, and at the same time receives and measures the electric potential difference, amplitude and phase (real and imaginary components) of each dominant frequency on the ground, the relative phase among every dominant frequency, and then calculates many kinds of parameters, such as the apparent resistivity, amplitude frequency ratio of every dominant frequency.

What is claimed is:

1. A kind of observation system for pseudo-random waveform electric current signal, including the transmitter and receiver.
